(19) United States
(12) Patent Application Publication
(10) Pub. No.: US 2004/0243515 A1
(43) Pub. Date: Dec. 2, 2004

(54) Transaction method and automatic transaction apparatus for carrying out same

(75) Inventors: Makoto Kurihara, Kawasaki (JP); Kazuyoshi Yokota, Kawasaki (JP); Setsuo Tsukui, Kawasaki (JP); Yoshio Onawa, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 10/882,333

(22) Filed: Jul. 2, 2004

Related U.S. Application Data
(63) Continuation of application No. PCT/JP02/00621, filed on Jan. 28, 2002.

(51) Int. Cl. G06F 17/60

(52) U.S. Cl. 705/41

(57) ABSTRACT

In a transaction with an automatic transaction apparatus, necessary processes for a transaction in front of the automatic transaction apparatus are carried out in advance utilizing portable communication terminals, and information (transaction authentication information) on the preceding processes executed in advance is transmitted from the portable communication terminal to the automatic transaction apparatus. Thereby, there is no need to input again the information necessary for the transaction into the automatic transaction apparatus and reduction of the time necessary for the transaction by the time necessary for the above inputting can be facilitated.

### TECHNICAL FIELD

The present invention relates generally to a transaction method for an automatic transaction apparatus such an ATM (Automatic Teller Machine) installed in a financial institution such as a bank, and more particularly, to a transaction method capable of reducing transaction time necessary for a transaction handling an article to be transacted such as cash.

### PRIOR ART

Transactions such as depositing, withdrawal and transfer of money utilizing automatic transaction apparatuses such as ATMs installed in stores of financial institutions and stores such as convenience stores are prevailing. In a transaction utilizing an automatic transaction apparatus, for example, a customer inputs information necessary for the transaction using keys or a touch panel attached to the automatic transaction apparatus. For example, in the case of a transaction for transfer, there are many items of information to be inputted such as the personal identification number, name of the financial institution to be transferred to, an account number, name of transferor, the amount of be transferred. Therefore, the time necessary for one (1) transaction tend to become longer and long queues of customers may be caused to form in front of the automatic transaction apparatus.

On the other hand, in recent years, due to the growth of networks such as the Internet, financial transactions utilizing communication terminals are also prevailing. Thereby, without utilizing automatic transaction apparatuses, transfer transactions using communication terminals such as a personal computer and a mobile phone are also possible.

As described above, opportunities to utilize automatic transaction apparatuses are decreased for transfer transactions by enabling carrying out of transfer transactions with other apparatuses other than the automatic transaction apparatuses. Thereby, decrease of the queues of customers is facilitated.

However, a transfer transaction is to move money from an account to another account and it does not handle any article to be transacted such as cash. Therefore, without utilizing any automatic transaction apparatus, transactions utilizing communication terminals such as a mobile phone and a personal computer can be possible. However, for the transactions that need handling of articles to be transacted such as depositing and withdrawal transactions, transactions utilizing automatic transaction apparatuses are necessary. In addition, among the transactions utilizing automatic transaction apparatuses, depositing and withdrawal transactions are overwhelmingly more compared with the transfer transactions.

### DISCLOSURE OF THE INVENTION

The object of the invention is to provide a transaction method capable of reducing the time necessary for the transactions and an automatic transaction apparatus for executing the method in transactions handling articles to be transacted.

Another object of the invention is to provide a transaction method capable of executing depositing and withdrawal transactions without utilizing ATM cards and an automatic transaction apparatus for executing the method.

The configuration of a transaction method of the invention to achieve the above objects is such that the transmission method utilizing an automatic transaction apparatus for carrying out predetermined transactions handling articles to be transacted through communication with a host computer, comprises the steps of, a portable communication terminal transmitting to the host computer transaction information necessary for a transaction with the automatic transaction apparatus and receiving transaction authentication information corresponding to the transaction information that has been produced, stored and returned by the host computer; and, the automatic transaction apparatus receiving the transaction authentication information transmitted from the portable communication terminal, transmitting the received transaction authentication information to the host computer and carrying out the transaction based on response information corresponding to the transaction authentication information received from the host computer.

As described above, necessary processes for a transaction with an automatic transaction apparatus have been carried out in advance utilizing portable communication terminals and information on the preceding processes executed in advance (transaction authentication information) is transmitted from the portable communication terminal to the automatic transaction apparatus. Thereby, there is no need to input again the information necessary for the transaction into the automatic transaction apparatus and reduction of the time necessary for the transaction by the time necessary for the above inputting can be facilitated.

Furthermore, in the case where a transaction carried out with an automatic transaction apparatus is a depositing/withdrawal transaction using cash, the authentication process is executed at a host computer of a financial institution based on the information inputted from a portable communication terminal. Therefore, without an ATM card, depositing/withdrawal transactions can be possible. That is, the portable communication terminal plays the role of the ATM card.

According to the invention, there are provided an automatic transaction apparatus and a portable communication terminal for carrying out such a transaction method as above.

### BRIEF DESCRIPTION OF THE DRAWINGS

FIG. 1 illustrates generally a system for implementing an automatic transaction method in an embodiment of the invention.

FIG. 2 is a schematic appearance view of an automatic transaction apparatus in the embodiment of the invention.

FIG. 3 is a block diagram of the structure of the automatic transaction apparatus in the embodiment of the invention.

FIG. 4 is a flowchart of a preceding process utilizing a portable communication terminal in the embodiment of the invention.

FIG. 5 is a flowchart of a post-process utilizing the automatic transaction apparatus in the embodiment of the invention.

FIGS. 6A to 6F show examples of transaction screens displayed on the portable communication terminal during the process shown in FIG. 4.

FIG. 7A to 7D show examples of transaction screens displayed on the automatic transaction apparatus during the process shown in FIG. 5.

FIG. 8A to 8C show examples of transaction screens displayed on the portable communication terminal during the process shown in FIG. 5.

### BEST MODE FOR CARRYING OUT THE INVENTION

An embodiment of the invention will be described referring to the drawings. However, the technical scope of the invention is not limited to the embodiment.

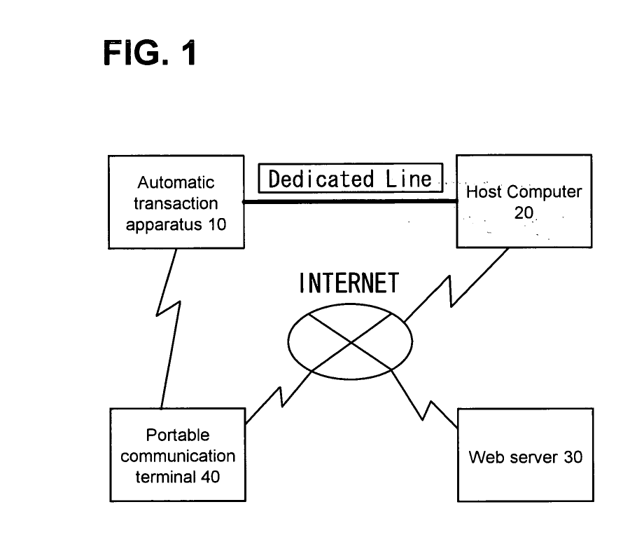

FIG. 1 illustrates generally a system for implementing a transaction method in an embodiment of the invention. An automatic transaction apparatus (for example, an ATM) 10 is connected with a host computer 20 in a financial institution through a dedicated line. The host computer 20, a web server 30 for providing a predetermined financial transaction site and a portable communication terminal 40 can communicate with each other through a public network such as the Internet. Furthermore, the portable communication terminal 40 and the automatic transaction apparatus 10 can also communicate with each other by communication means of, for example, IR communication, a radio LAN etc. The portable communication terminal 40 is, for example, a mobile phone or a mobile computer.

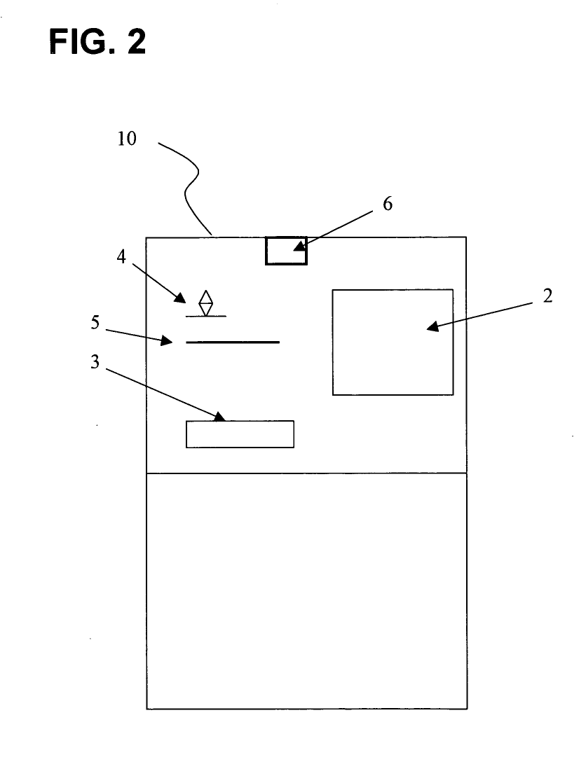

FIG. 2 is a schematic appearance view of an automatic transaction apparatus in the embodiment of the invention. The automatic transaction apparatus 10 shown in FIG. 2 comprises a customer operation screen 2, a cash inlet/outlet 3, a card inlet/outlet 4, a receipt outlet 5 and an information receiving unit 6. A customer advances a transaction by predetermined inputting operation by touching predetermined portions on a screen watching a screen 2.

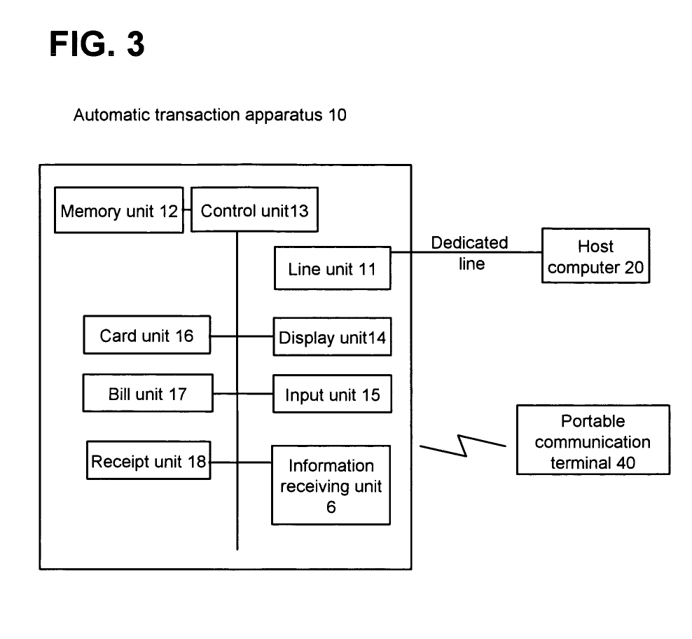

FIG. 3 is a block diagram of the structure of the automatic transaction apparatus 10 shown in FIG. 2. A host line unit 11 in the automatic transaction apparatus 10 is connected with the host computer of the financial institution through the dedicated line. The host computer 20 executes authentication processes in depositing/withdrawal transactions by communication with the automatic transaction apparatus 10. Process steps of transactions such as depositing and withdrawal transactions in the automatic transaction apparatus 10 are stored in a memory unit 12 as a program and a control unit 13 having a CPU etc. executes the program. Thereby, the contents of a transaction according to each process step are displayed on the screen 2 of a display unit 14. Then, based on inputted information from an input unit 15 (for example, a touch panel arranged on the screen 2), a card unit 16, a bill unit 17, a receipt unit 18 etc. are operated. The card unit 16 reads magnetic stripes on a card inserted through the card inlet/outlet 4. The bill unit 17 stores bills having been put through the cash inlet/outlet 3, in a predetermined storage unit, or it discharges bills from the storage unit to the cash inlet/outlet 3. The receipt unit 18 issues a receipt for verifying a transaction from the receipt inlet/outlet 5. Furthermore, as described later, the information receiving unit 6 receives data (transaction authentication information) transmitted from the portable communication terminal of the customer.

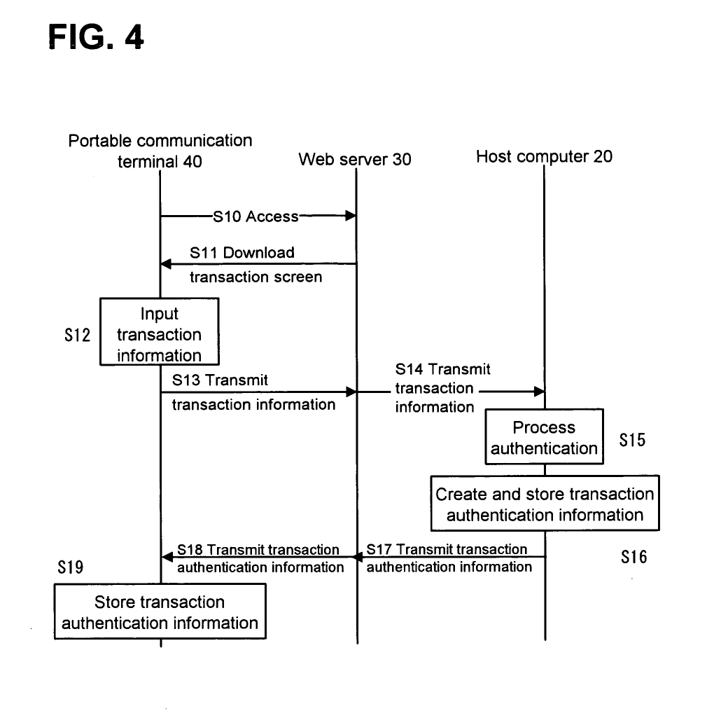

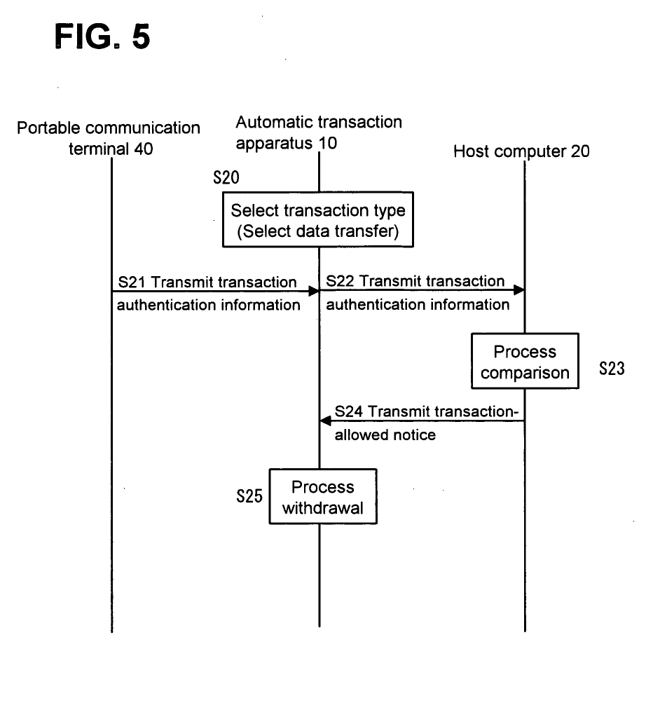

FIGS. 4 and 5 are process flowcharts of a transaction method in the embodiment of the invention. A business entity such as a financial institution providing the transaction method of the embodiment provides transactions in which transaction steps executed through a network such as the Internet and transaction steps executed by the automatic transaction apparatus are combined. The business entity prepares a transaction site for executing the following process in advance in the web server 30. First, at an arbitrary place, the customer connects the portable communication terminal 40 with the web server 30 by operating the portable communication terminal 40. The web server 30 is communicable with the host computer 20 through a network. Thereby, communication between the portable communication terminal 40 and the host computer 20 is carried out through the web server 30 and a process shown in the following FIG. 4 is carried out between the portable communication terminal 40 and the host computer 20.

FIG. 4 is a flowchart of a preceding process utilizing the portable communication terminal 40 in the embodiment of the invention. In FIG. 4, by the operation of the customer, the portable communication terminal 40 makes an access to the web server (S10) and downloads a transaction screen from the transaction site to the portable communication terminal 40 (S11). The customer inputs information necessary for the transaction into the portable communication terminal according to the transaction screen having been downloaded (S12).

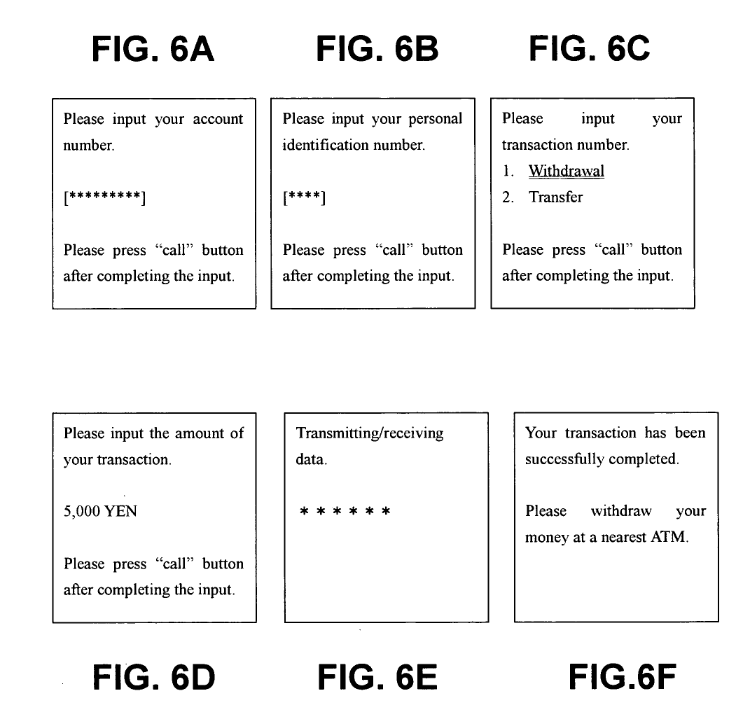

FIGS. 6A to 6F show examples of transaction screens displayed on the portable communication terminal 40 during the process shown in FIG. 4. More specifically, FIG. 6A shows an example of a screen for inputting an account number. FIG. 6B shows an example of a screen for inputting a personal identification number. FIG. 6C shows an example of a screen for selecting the type of the transaction. FIG. 6D shows an example of a screen for inputting the amount to be transferred. FIG. 6E shows an example of a screen for transmitting data. FIG. 6F shows a screen for concluding a transaction (at the transaction site). The customer inputs the account number, the personal identification number, the type of the transaction and the amount to be transferred in the order of FIGS. 6A, 6B, 6C and 6D. The types of the transaction are not limited to the transactions such as depositing, withdrawal for which transactions with an automatic transaction apparatus are necessary and transactions such as transferring for which transactions with an automatic transaction apparatus are not necessary (transactions that are concluded within a transaction site) may be set. However, in the following embodiment, a withdrawal transaction that needs a transaction with an automatic transaction apparatus will be described as an example.

The portable communication terminal 40 transmits transaction information such as the account number inputted by a customer, a personal identification number, the type of the transaction (in this embodiment, “withdrawal”), the amount to be disbursed, etc. to the web server 30 through a network (S13). The web server 30 further transfers the received transaction information to the host computer 20 of the financial institution (S14). A standby screen shown in FIG. 6D is displayed on the portable communication terminal 40 until a response from the host computer 20 is received.

The host computer 20 executes an authentication process to the received transaction information (S15). When the information is authenticated, the host computer produces transaction authentication information for the transaction information and stores the transaction information and the transaction authentication information relating them with each other (S16). The transaction authentication information contains a transaction identifier (such as a transaction number) for identifying the transaction corresponding to the transaction information. Preferably, to the transaction authentication information, the term of validity of the transaction authentication information itself is also set and, as described later, in the case where the host computer 20 has not received identical transaction authentication information from the automatic transaction apparatus within the term of validity, the host computer 20 makes the transaction corresponding to the transaction information invalid.

The host computer 20 transmits the produced transaction authentication information to the web server 30 (S17) and the web server 30 further transfers the transaction authentication information to the portable communication terminal 40 (S18). When the portable communication terminal 40 stores normally the received transaction authentication information, the screen for concluding the transaction shown in FIG. 6F is displayed.

Along with the transaction identifier, the transaction authentication information containing information concerning the above term of validity (information being a portion of the transaction information and containing the date and the time of production of the transaction identifier plus the term of validity, or the date and the time of the term of validity etc.) may be transmitted to the portable communication terminal 40. Preferably, when the transaction authentication information has not been transmitted to the host computer 20 within the term of validity, the portable communication terminal 40 deletes the stored transaction authentication information when the term of the validity has passed.

As described above, when the process between the portable communication terminal 40 and the host computer 20 has been concluded, the customer carries out a transaction with the automatic transaction apparatus using the portable communication terminal 40 storing the above transaction authentication information.

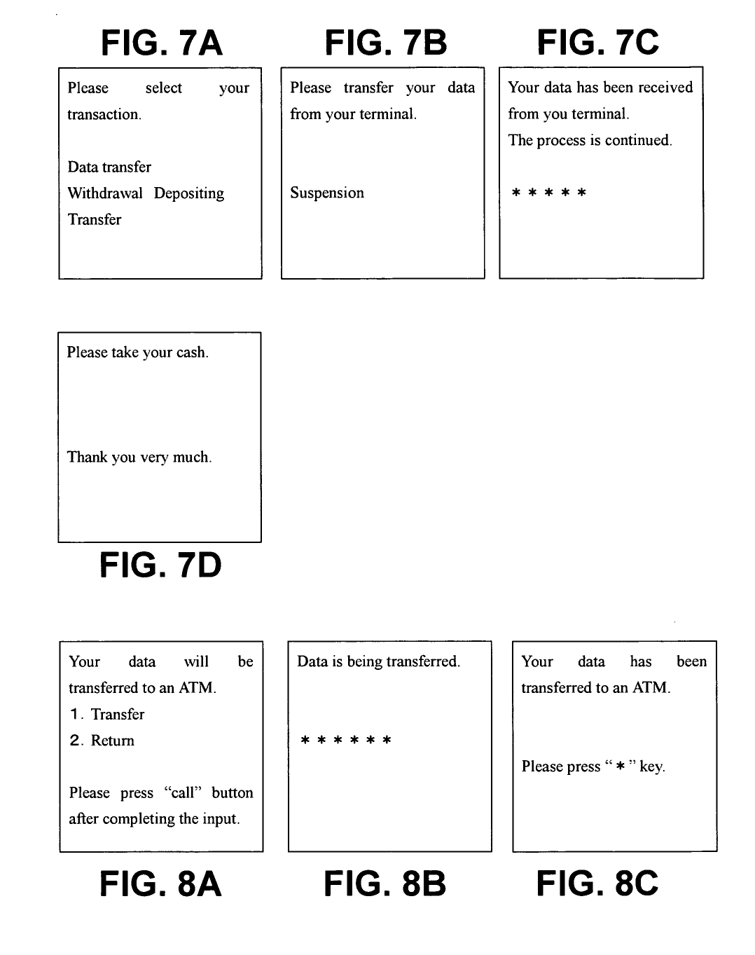

FIG. 5 is a flowchart of a post-process utilizing the automatic transaction apparatus in the embodiment. FIGS. 7A to 7D shows examples of transaction screens displayed on the automatic transaction apparatus 10 in the process shown in FIG. 5. FIG. 7A shows an example of a screen for selecting the type of transaction. FIG. 7B shows an example of a screen of standby for transmission of information from the portable communication terminal 40. FIG. 7C shows an example of a screen for verifying receipt of the information. FIG. 7D shows an example of a screen for concluding the transaction. Furthermore, FIGS. 8A to 8C show examples of transaction screens displayed on the portable communication terminal 40 during the process shown in FIG. 5. FIG. 8A shows an example of a screen for instructing transmission of information. FIG. 8B shows an example of a screen indicating transmission. FIG. 8C shows an example of a screen for concluding the transmission.

First, in the automatic transaction apparatus 10, a type of transaction is selected from a screen for selecting the type of transaction (FIG. 7A) being the initial screen by operation of a customer (S20). More specifically, “Data Transfer” in FIG. 7A is selected. Thereby, a screen shown in FIG. 7B is displayed and the automatic transaction apparatus 10 is in a state of data (transaction authentication information) transmission standby from the portable communication terminal 40.

Then, in the portable communication terminal 40, a process for transmitting the transaction authentication information obtained in the process shown in FIG. 4 to the automatic transaction apparatus 10 is executed by the operation of the customer. More specifically, the customer causes the screen shown in FIG. 8A to be displayed on the portable communication terminal 40 and carries out data transmission operation and the portable communication terminal 40 transmits the transaction authentication information to the automatic transaction apparatus 10 (S21) FIG. 8B shows the screen displayed on the portable communication terminal 40 during the transfer of the transaction authentication information, and the screen shown in FIG. 8C is displayed when the transfer has been completed.

The automatic transaction apparatus 10 displays the screen shown in FIG. 7C when it has received the transaction authentication information and it further transfers the received transaction authentication information to the host computer 20 connected through the dedicated line (S22).

When the host computer 20 has received the transaction authentication information, it executes a comparison process to the received transaction authentication information (S23). More specifically, in a host computer 22, a comparison of the transaction identifier contained in the received transaction authentication information with the transaction identifier of the transaction authentication information stored in the host computer 22 is carried out and, when there are transaction identifiers that coincide with each other, the transaction is determined to be allowed and, when there are no transaction identifiers that coincide with each other, the transaction is determined not to be allowed.

The host computer 20 returns the result of the comparison (transaction-allowed/transaction-not-allowed notice) to the automatic transaction apparatus 10 (S24). At this time, in the case where the transaction is allowed, the contents of the transaction (the type of the transaction [withdrawal]), the amount to be disbursed etc.) corresponding to the transaction authentication information are notified together with a notice to allow the transaction. In FIG. 5, a case where the transaction is allowed is exemplified.

When the automatic transaction apparatus 10 has received the notice to allow the transaction and the contents of the transaction, it executes a withdrawal process (S25) based on those received items and, when the process is completed, it causes the screen shown in FIG. 7D to be displayed and the process is concluded.

As described above, the transaction with the automatic transaction apparatus 10 can be possible only by transmitting transaction authentication information stored in the portable communication terminal 40 to the automatic transaction apparatus 10 in the transaction with the automatic transaction apparatus 10 by executing a pre-process (the process shown in FIG. 4) of the transaction using the portable communication terminal 40 before carrying out the transaction with the automatic transaction apparatus 10. That is, the transaction with the automatic transaction apparatus 10 can be possible without carrying out an operation for inputting the personal identification number and the amount to be deposited/disbursed etc., and as to the process for depositing/withdrawal, reduction of time necessary for the transaction with the automatic transaction apparatus can be facilitated.

As is obvious from the above embodiment, since the authentication for the transaction has been carried out in advance by the process between the portable communication terminal 40 and the host computer 20, transactions with the automatic transaction apparatus can be possible without using an ATM card. That is, it is possible to use the portable communication terminal in place of an ATM card.

In the above embodiment, in the process (shown in FIG. 4) between the portable communication terminal 40 and the host computer 20, the transaction identifier is transmitted from the host computer 20 to the portable communication terminal 40 as the transaction authentication information. However, in addition to the transaction identifier, the transaction information (the type of the transaction, the amount to be transacted, etc.) corresponding to it may be transmitted as transaction authentication information. In this case, in the process (shown in FIG. 5) between the portable communication terminal 40 and the automatic transaction apparatus 10, the portable communication terminal 40 transmits the transaction authentication information having the transaction identifier and the transaction information to the automatic transaction apparatus. Thereby, the automatic transaction apparatus 10 obtains the transaction information. Therefore, it is enough for the host computer 20 to return only the notice for allowing the transaction. Otherwise, the automatic transaction apparatus 10 may transmit the transaction identifier and the transaction information to the host computer 20 and the host computer 20 may execute not only the comparison for the transaction identifier but also the comparison for the transaction information.

In the case where the portable communication terminal is a mobile phone, the telephone number of the mobile phone. may be included in the transaction information as information for identifying a customer.

The embodiment can be applied to not only depositing/withdrawal transactions for cash but also transactions handling articles to be transacted other than cash. For example, in the case where an automatic transaction apparatus has a function for issuing public lottery tickets as articles to be transacted, a reservation for purchasing public lottery tickets has been made in advance with a host computer of the institution issuing public lottery tickets and the settlement of the amount payable for the purchase is completed and, thereafter, information of the completion of the settlement is transmitted to an automatic transaction apparatus. Thereby, at the automatic transaction apparatus, the public lottery tickets can be issued without any settlement process for the amount payable for the purchase and, therefore, the time necessary for the transaction with the automatic transaction apparatus can be reduced.

Furthermore, in the case of an automatic transaction apparatus having a function for paying charges for public utility etc., when it is necessary to issue a receipt, information of completion of a transfer is transmitted to the automatic transaction apparatus after a transfer process has been carried out between a portable communication terminal and a host computer of a financial institution. Thereby, it is possible to issue a receipt without executing any transfer process and, therefore, to reduce the time necessary for the transaction with the automatic transaction apparatus.

### Industrial Applicability

As described above, according to the invention, in a transaction utilizing an automatic transaction apparatus, inputting of information for which authentication by a host computer is necessary has been carried out in advance by a portable communication terminal. Therefore, it is possible to reduce the time necessary for a transaction with the automatic transaction apparatus.

Furthermore, it is possible to use a portable communication terminal in place of an ATM card for a transaction with an automatic transaction apparatus.

What is claimed is:

1. A transaction method utilizing an automatic transaction apparatus for carrying out predetermined transactions handling articles to be transacted through communication with a host computer, the method comprising the steps of:
a portable communication terminal transmitting to the host computer transaction information necessary for a transaction with the automatic transaction apparatus and receiving transaction authentication information corresponding to the transaction information that has been produced, stored and returned by the host computer; and
the automatic transaction apparatus receiving the transaction authentication information transmitted from the portable communication terminal, transmitting the received transaction authentication information to the host computer and carrying out the transaction based on response information corresponding to the transaction authentication information received from the host computer.

2. The transaction method according to claim 1, wherein the articles to be transacted is cash.

3. The transaction method according to claim 2, wherein the transaction is a transaction for depositing or withdrawal of cash.

4. The transaction method according to claim 1, wherein the transaction authentication information contains a transaction identifier for identifying the transaction information issued in the case where authentication is duly made by an authentication process, executed in the host computer, of the transaction information received from the portable communication terminal.

5. The transaction method according to claim 4, wherein the transaction authentication information contains information concerning its term of validity and, when the term of validity has passed, the transaction authentication information becomes invalid.

6. The transaction method according to claim 1, wherein the response information contains transaction-allowed/transaction-not-allowed information that is based on a comparison process, executed in the host computer, of the transaction authentication information received from the automatic transaction apparatus and the transaction authentication information stored in the host computer.

7. An automatic transaction apparatus for carrying out predetermined transactions handling articles to be transacted through communication with a host computer, the apparatus comprising:
receiving means for receiving transaction identification information from a portable communication terminal that transmits to the host computer transaction information necessary for a transaction with the automatic transaction apparatus, the portable communication terminal receiving the transaction identification information corresponding to the transaction information produced, stored and returned by the host computer;
communication means for transmitting the received transaction identification information to the host computer, the communication means receiving response information corresponding to the transaction identification information from the host computer; and
transaction means for carrying out the transaction based on the response information.

8. The automatic transaction apparatus according to claim 7, wherein the articles to be transacted is cash.

9. The automatic transaction apparatus according to claim 8, wherein the transaction is a transaction for depositing or withdrawal of cash.

10. The automatic transaction apparatus according to claim 7, wherein the transaction authentication information contains a transaction identifier for identifying the transaction information issued in the case where authentication is duly made by an authentication process, executed in the host computer, of the transaction information received from the portable communication terminal.

11. The automatic transaction apparatus according to claim 10, wherein the transaction authentication information contains term-of-validity information that concerns its term of validity and that, when the term of validity has passed, makes the transaction authentication information invalid.

12. The automatic transaction apparatus according to claim 7, wherein the response information contains transaction-allowed/transaction-not-allowed information that is based on a comparison process, executed in the host computer, of the transaction authentication information received from the automatic transaction apparatus and the transaction authentication information stored in the host computer.

13. A portable communication terminal comprising:
display means for displaying screens for inputting transaction information necessary for a transaction with an automatic transaction apparatus for carrying out predetermined transactions handling articles to be transacted through communication with a host computer;
communication means for transmitting the inputted transaction information to the host computer and receiving transaction authentication information corresponding to the transaction information transmitted from the host computer; and
transmitting means for transmitting the received transaction authentication information to the automatic transaction apparatus.
